(19) United States
(12) Patent Application Publication
(10) Pub. No.: US 2026/0172268 A1
(43) Pub. Date: Jun. 18, 2026

(54) PHYSICALLY UNCLONABLE FUNCTION DIVERSIFICATION

(71) Applicant: Cryptography Research, Inc., San Jose, CA (US)

(72) Inventors: Matthew E. ORZEN, San Francisco, CA (US); Joel WITTENAUER, Pleasanton, CA (US)

(21) Appl. No.: 19/411,724

(22) Filed: Dec. 8, 2025

Related U.S. Application Data
(60) Provisional application No. 63/735,213, filed on Dec. 17, 2024.
(60) Provisional application No. 63/746,727, filed on Jan. 17, 2025.

(51) Int. Cl. H04L 9/32; H04L 9/08

(52) U.S. Cl. CPC H04L 9/3278; H04L 9/0861

(57) ABSTRACT

Helper data and/or physically unclonable function (PUF) output data may be analyzed to determine which bits of the raw PUF output are stable. A first subset of the stable PUF output bits are selected (e.g., randomly) to generate a first stable PUF output value to be used as a first device unique value. To change the device unique value (a.k.a., digital fingerprint or fingerprint) of the integrated circuit generated by the PUF circuitry, new subsets (which may be generated off-chip) with different stable PUF output bits may be provided to the integrated circuit (i.e., provisioned) from time to time (e.g., with a new firmware/software update, after some arbitrary period of time—e.g., one year—etc.). Each new and different subset of stable bits used by the integrated circuit causes the integrated circuit to generate new, and different, device unique values.

### BRIEF DESCRIPTION OF THE DRAWINGS

FIGS. 1A-1D illustrate cloud based integrated circuit identification.

FIGS. 2A-2D are notional diagrams illustrating physically unclonable function diversification.

FIG. 3 illustrates a provisioning system.

FIG. 4 is a flowchart illustrating a method of provisioning an integrated circuit.

FIG. 5 is a flowchart illustrating a method of physically unclonable function diversification.

FIG. 6 is a flowchart illustrating a method of diversified helper data to produce a plurality of physically unclonable function output values.

FIG. 7 is a flowchart illustrating a method of generating a plurality of physically unclonable function output values from raw physically unclonable function output bits.

FIG. 8 is a block diagram of a processing system.

### DETAILED DESCRIPTION OF THE EMBODIMENTS

A “physically unclonable function” (PUF) circuit is a circuit that generates a physically-defined “digital fingerprint” that may serve as a unique identifier for a semiconductor device—such as a microprocessor, security, authentication, and/or cryptographic function die. In general, PUF circuits rely on unique physical variations that occur naturally, and inevitably, during integrated circuit manufacturing. Since these variations are smaller than can be reliably generated by classically reproducible circuits, so-call “helper data” is generated for each integrated circuit die with a PUF circuit to ensure the PUF outputs on that die are reproducible over time even though the PUF circuit is not.

In an embodiment, the helper data for a particular integrated circuit die may be analyzed to determine which bits of the raw PUF output are stable. One or more subsets of the stable PUF output bits are selected (e.g., randomly) to generate a corresponding one or more stable PUF output values. In other words, for each stable PUF output value to be generated by the integrated circuit, some number of stable PUF output bits may be “masked” in order to create multiple unique stable PUF output values that have different values from each other. The applied “masks” may also, for example, re-order the stable and/or masked PUF output bits. To change the device unique value (a.k.a., digital fingerprint or fingerprint) of the integrated circuit generated by the PUF circuitry, new masks from the generated set of masks may be provided to the integrated circuit (i.e., provisioned) from time to time (e.g., with a new firmware/software update, after some arbitrary period of time—e.g., one year—etc.). Each new mask used by the integrated circuit causes the integrated circuit to generate new, and different, device unique values.

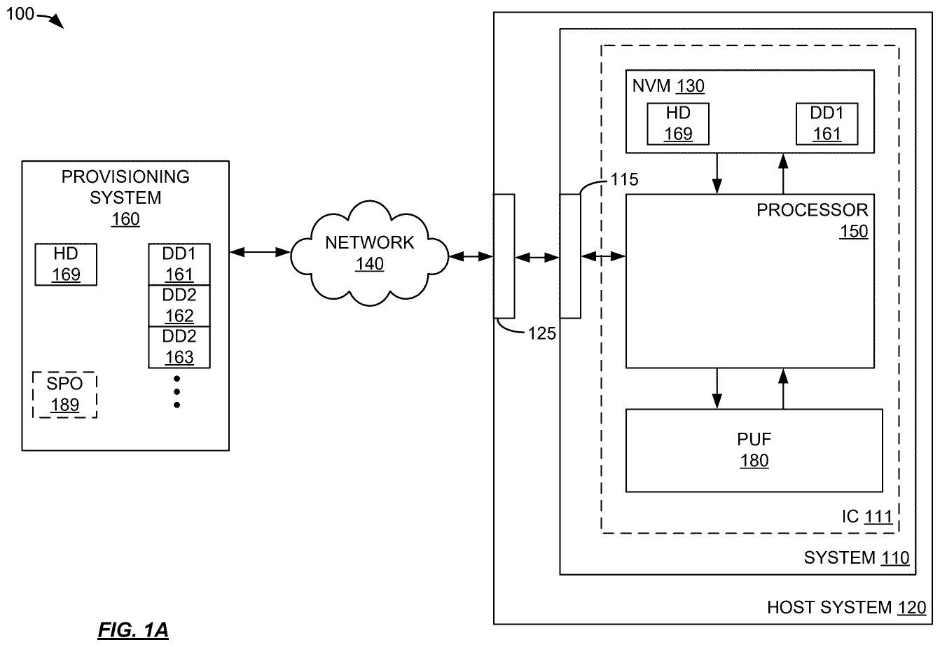

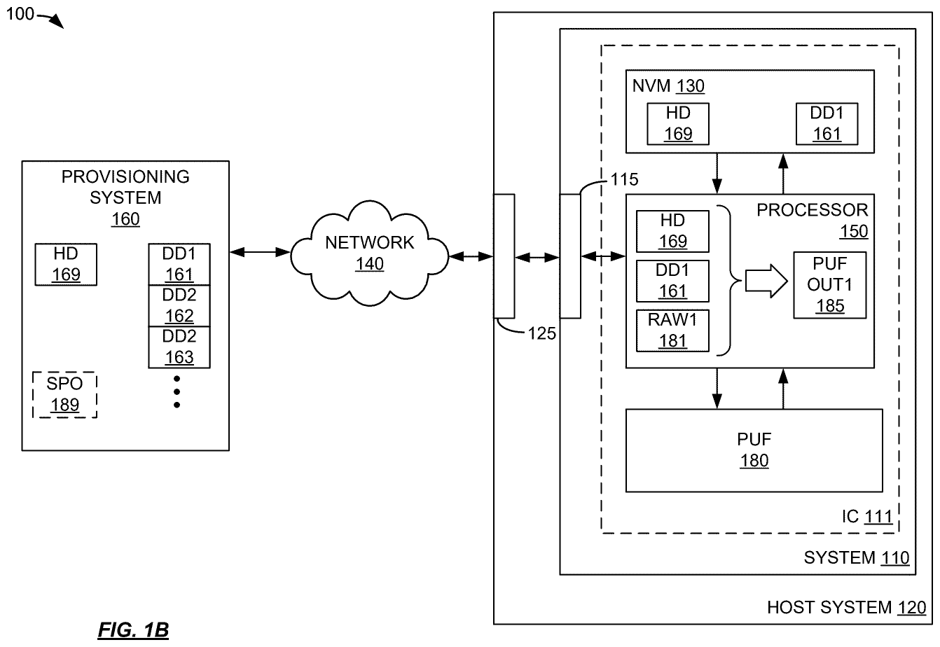

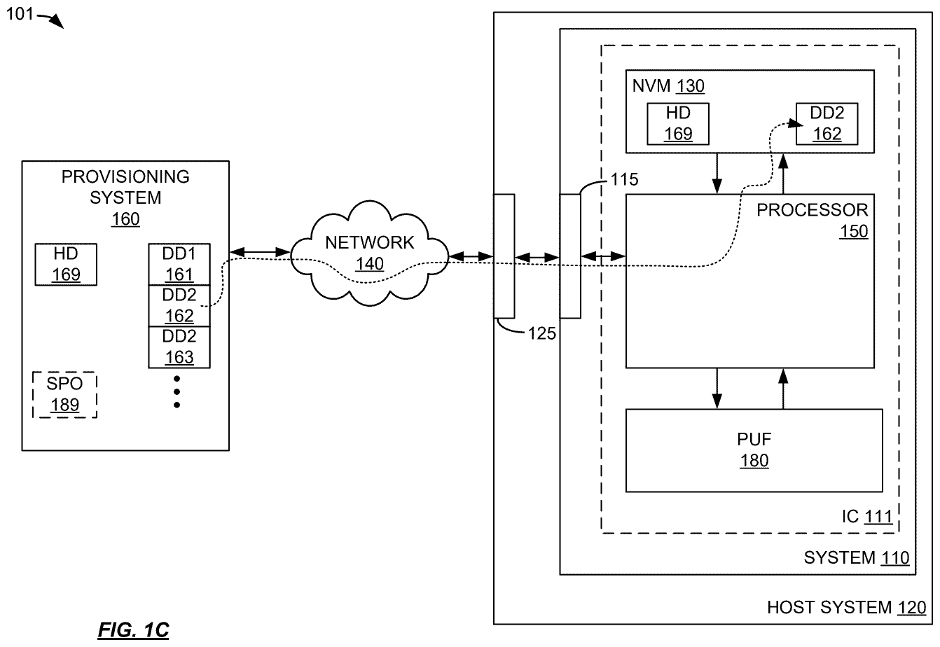

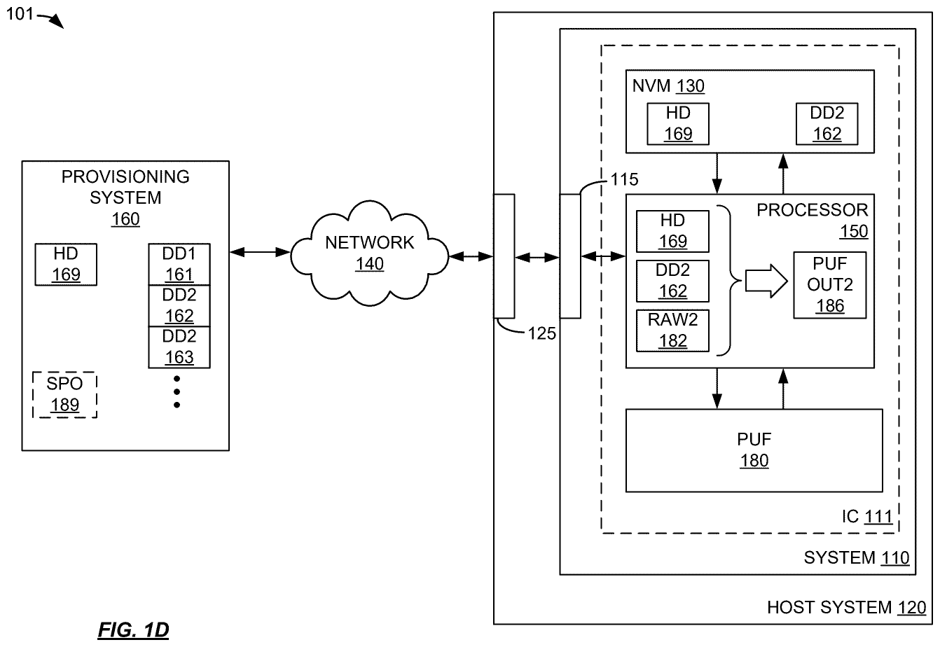

FIGS. 1A-1D illustrate cloud based integrated circuit identification. In FIGS. 1A-1D, identification system 100 comprises system 110, host system 120, network 140, and provisioning system 160. System 110 includes nonvolatile memory (NVM) 130, processor 150, physically unclonable function (PUF) circuitry 180, and interface 115. NVM 130, processor 150, and PUF circuitry 180 may be included on an implementation of an identification/security/authentication integrated circuit 111. Provisioning system 160 includes a plurality of diversification data masks 161-163, helper data 169, and optionally stable PUF output value 189.

System 110 is operatively coupled to host system 120 via interface 115. System 110 is operatively coupled to host system 120 to at least provide device unique values associated with PUF circuitry 180 to host system 120. System 110 may be, for example, a printer cartridge. Host system 120 may be part of, for example, a printer that authenticates system 110 using a device unique value produced by integrated circuit 111 to ensure the printer is not using a counterfeit printer cartridge.

Host system 120 is operatively coupled to provisioning system 160 via interface 125 and network 140. Host system 120 is operatively coupled to provisioning system 160 to receive, for example, helper data 169 and/or diversification data masks 161-163. Network 140 can comprise wired and/or wireless communication networks that include processing nodes, routers, gateways, physical and/or wireless data links for carrying data among various network elements, including combinations thereof, and can include a local area network, a wide area network, and an internetwork (including the Internet). In other words, host system 120 may be operatively coupled to provisioning system 160 by any means that can provide communication between host system 120 and provisioning system 160. In an embodiment, provisioning system 160 is a software process executing on an internet connected server. Other elements may be present to facilitate communication to/from host system 120 and provisioning system 160 but are omitted for clarity, such as physical media, additional processors, routers, gateways, and physical and/or wireless data links for carrying data.

Processor 150 of system 110 is operatively coupled to NVM 130 and PUF circuitry 180. Processor 150 is operatively coupled to interface 115. Processor 150 may communicate with host system 120 via interface 115. In an embodiment, PUF circuitry 180, is used to generate a fingerprint value based on chip-unique variations of the physical characteristics (e.g., resistance, capacitance, threshold voltage, connectivity, etc.) of PUF circuitry 180. PUF circuitry 180 may additionally include one or more tamper prevention (i.e., shielding) structures. The physical characteristics depend on random physical factors introduced during manufacturing. This causes the chip-to-chip variations in these physical characteristics to be unpredictable and uncontrollable which makes it virtually impossible to duplicate, clone, or modify PUF circuitry 180 and/or the tamper prevention structures without changing the fingerprint value.

In an embodiment, NVM 130 is provisioned with and stores helper data 169 and diversification data mask 161. As described herein, the role of PUF circuitry 180 is to exploit manufacturing variations to derive a chip-unique digital identifier or fingerprint. The fingerprint is thus tied to a specific instance of manufactured PUF circuitry 180. There are many of examples of PUF circuitry, and many of them are arranged to produce a noisy bit string either on its own or after having an optional challenge stimulus (e.g., voltage, current, digital value, etc.) provided to it. The noisy bit stream is typically referred to as a raw PUF output value. The stimulus is typically referred to as a PUF challenge (a.k.a., PUF challenge stimulus). For example, PUF circuitry 180 may be controlled or ‘challenged’ to produce a noisy bit string. When PUF circuitry 180 is challenged multiple times, PUF circuitry 180 may produce different noisy bit streams (i.e., raw PUF output values) one or more times. Resolving the differences in these noisy bit streams to a single, stable fingerprint value that is output by PUF circuitry 180 is resolved using helper data 169. Helper data 169 may include, for example, stable bit indicators, error correcting code(s), etc. Helper data is more formally defined in Armkenecht et al., “A Formal Foundation for the Security Features of Physical Functions” Proceedings 2011 IEEE Symposium on Security and Privacy, pages 397-412, 2011, which is hereby incorporated herein by reference for all purposes.

In an embodiment at least partially illustrated in FIG. 1B, nonvolatile memory 130 of system 110 is provisioned with helper data 169 and diversification data mask 161. System 110 may be provided helper data 169 and diversification data mask 161 by an initial configuration/manufacturing system not shown in FIGS. 1A-1D. Prior or near the start of an identification sequence, helper data 169 and diversification data mask 161 are communicated to processor 150. Note that in some embodiments, helper data 169 and/or diversification data mask 161 may be stored in an unencrypted format.

Processor 150 also receives, from PUF circuitry 180, a first raw PUF output value 181. Raw PUF output value 181 may include unstable bits. Thus, it should be understood that raw PUF output value 181 may be different each time PUF circuitry 180 is controlled to produce a raw PUF output value. Processor 150 uses helper data 169 to select stable bits from, and apply error correction to, raw PUF output value 181. Selected and corrected stable bits from raw PUF output value 181 are further processed by processor 150 according to diversification data mask 161 (which may also apply error correction) to produce first PUF output value 185.

There are many approaches by which the first PUF output value 185 may be used. For example, the first PUF output value could be used as a private key (or as an input to a private key derivation process). Software running on host system 120 might utilize a challenge/response protocol (e.g., similar to the public/private authentication process used by the standard “SSH” protocol) to verify authenticity of system 110. If stable PUF output value 189 is known outside of integrated circuit 111 (e.g., by provisioning system 160), the first PUF output value may be used as, or used to derive, a pre-shared key. In other words, if stable PUF output value 189 is known outside of integrated circuit 111, the first PUF output value could be used either as a key, as a shared secret, or as an input to a key/secret derivation process. Other approaches might selectively enable or disable different subsystems within system 110, based on the first PUF output value. In general, the use of different and/or unique diversification data blocks 161-163 as described herein can be made compatible with any identification/security/authentication/etc. process that itself is compatible with PUF technology.

Because system 110 initially is not provided with diversification data masks 162-163, an adversary cannot determine the stable PUF output values diversification data masks 162-163 will cause to be generated. In other words, even if an adversary were to fully compromise the NVM 130 of system 110 and thereby know all of its contents, the adversary cannot determine a second PUF output value that is associated with diversification data mask 162 until system 110 is provided diversification data mask 162. Likewise, an adversary cannot determine a third PUF output value that is associated with encrypted diversification data mask 163 until system 110 is provided diversification data mask 163, and so on.

Thus, for example, if an adversary obtains the first PUF output value that is associated with diversification data mask 161, plus all of the NVM contents (including helper data 169), system 110 may be updated (e.g., via provisioning system 160 and network 140) to start using a different diversification data mask 162 that produces a different device unique PUF output value that is not known by system 110 until system 110 is provided with the new diversification data mask 162. Thus, even though the adversary may have copies of the helper data and a past diversification data mask 161 from NVM 130 because the stable bits produces by PUF circuitry 180 are unclonable.

This process is further illustrated with reference to FIG. 1C and FIG. 1D. In FIG. 1C, diversification data mask 162 is provided to system 110 via network 140, interface 125, and interface 115 as part of a provisioning process. This is illustrated in FIG. 1C by the dotted line arrow from diversification data mask 162 in provisioning system 160 to diversification data mask 162 in NVM 130. In addition, diversification data mask 161 in NVM 130 may be deleted or otherwise made unusable in order to help thwart roll back attacks where system 110 is tricked or modified into using obsolete diversification data mask 161 to create and use a PUF output value that has been compromised or otherwise become known.

In FIG. 1D, nonvolatile memory 130 of system 110 is now provisioned with helper data 169 and diversification data mask 162. Prior or near the start of an identification sequence, helper data 169 and diversification data mask 162 are communicated to processor 150. Note that in some embodiments, helper data 169 and/or diversification data mask 162 may be stored in an unencrypted format. Processor 150 also receives, from PUF circuitry 180, a second raw PUF output value 182. Raw PUF output value 182 may include unstable bits. Thus, it should be understood that raw PUF output value 182 may be different each time PUF circuitry 180 is controlled to produce a raw PUF output value. Processor 150 uses helper data 169 to select stable bits from raw PUF output value 182. Selected stable bits from raw PUF output value 182 are further processed by processor 150 according to diversification data mask 162 to produce second PUF output value 186.

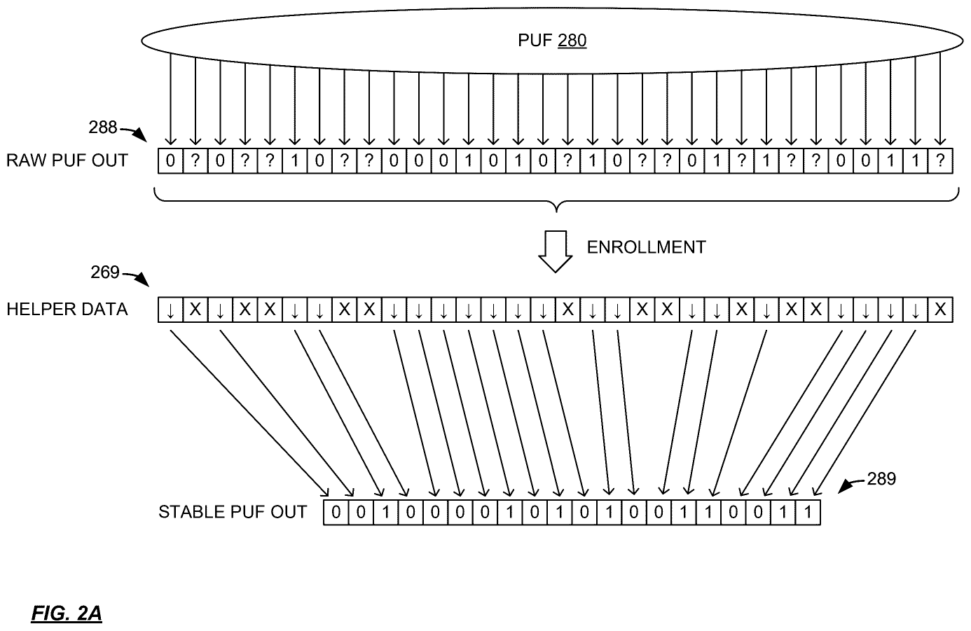

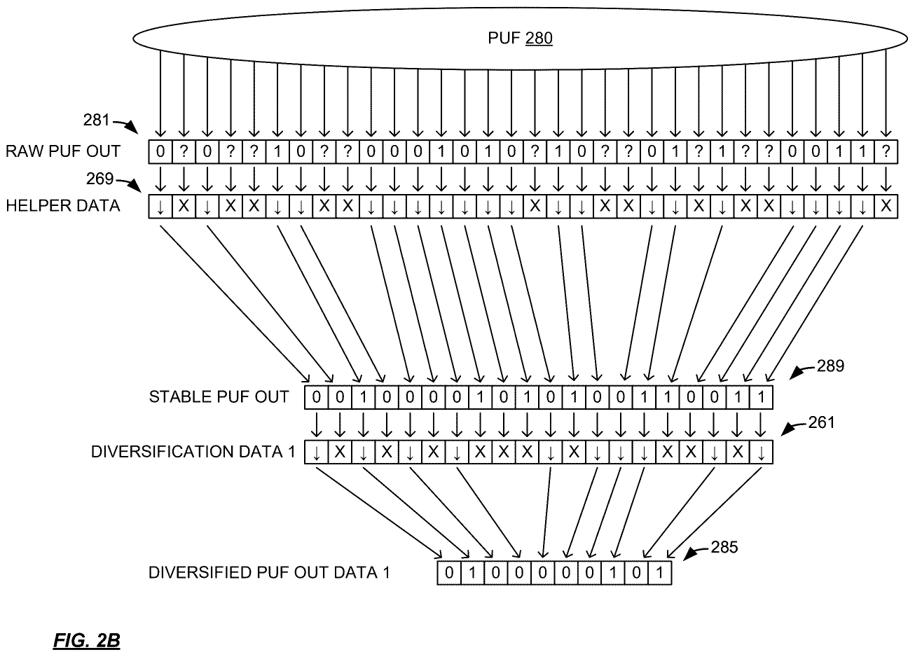

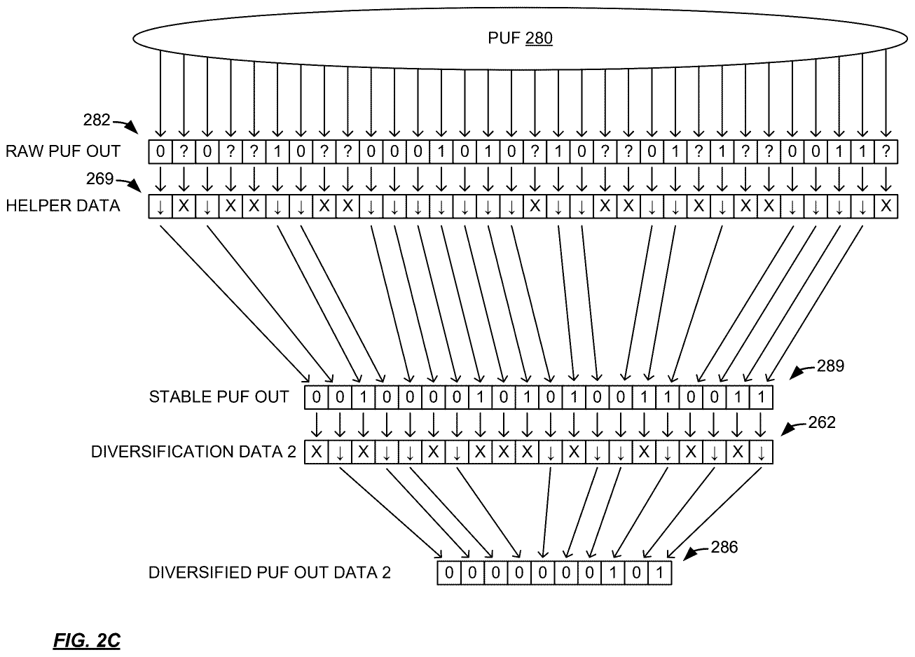

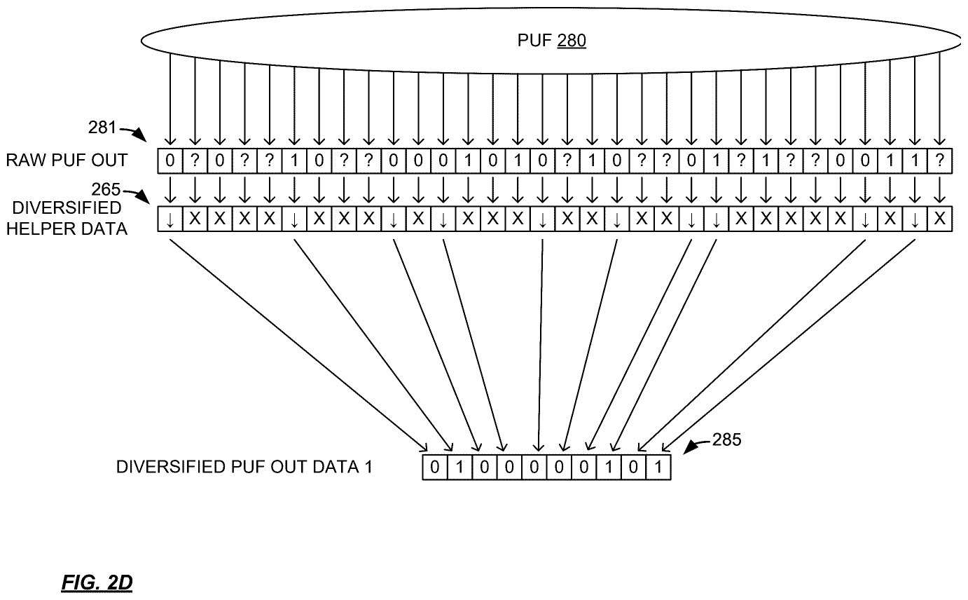

FIGS. 2A-2D are notional diagrams illustrating physically unclonable function diversification. In FIG. 2A, PUF circuitry 280 is controlled to generate a multitude (e.g., 1,000, 10,000, etc.) of raw PUF output bits 288 that are analyzed to determine which PUF circuitry 280 output bits meet a stability criteria and which PUF circuitry 280 output bits do not. This is illustrated in FIG. 2A as thirty-two example raw PUF output bits 288 that are indicated to be either a “1”, a “0”, or a “?” (0?0??10??0001010?10??01?1??0011?). The example raw PUF output bits 288 that have been determined to be unstable are indicated by the question mark “?” in the example raw PUF output bits 288 from PUF 280. The example raw PUF output bits 288 that have been determined to be a stable “1” (or stable enough to produce, possibly using error correction, a stable device unique value) are indicated by a “1” in the raw output bits from PUF 280. The example raw PUF output bits 288 that have been determined to be a stable “0” (or stable enough to produce, possibly using error correction, a stable device unique value) are indicated by a “0” in the raw output bits from PUF 280.

Based on the information from the multitude (e.g., 1,000, 10,000, etc.) of raw PUF output values produced by PUF circuitry 280, helper data 269 that masks the unstable bits, and passes the stable bits is generated. This is illustrated in FIG. 2A by the “X” in bit positions of helper data 269 corresponding to unstable raw PUF output bits 288 and arrows (↓) in bit positions of helper data 269 corresponding to stable raw PUF output bits 288. The stable raw PUF output bits are then coalesced into twenty example bits of stable PUF output value 289 (00100001010100110011).

In FIG. 2B, a first raw PUF output value 281 is produced by PUF circuitry 280. Helper data 269 is used to produce stable PUF output value 289. First diversification data mask 261 is used to mask a first set of selected bits of stable PUF output value 289 and thereby use a first subset of bits. Masked bits are illustrated in FIG. 2B by the “X” in bit positions of diversification data mask 261 and unmasked bits illustrated by arrows (↓) in bit positions of diversification data mask 261. The unmasked stable PUF output bits are then coalesced into ten example bits of a first PUF output value 285 (0100000101).

In FIG. 2C, a second raw PUF output value 282 is produced by PUF circuitry 280. Second raw PUF output value 282 is different from the first raw PUF output value 281 based at least in part on the fact that the unstable bits in the first raw PUF output value 281 may have different values when compared to the corresponding unstable bits in the second raw PUF output value 282. Helper data 269 is used to produce stable PUF output value 289. Second diversification data mask 262 is used to mask a second set of selected bits of stable PUF output value 289 and thereby use a second subset of bits. Masked bits are illustrated in FIG. 2C by the “X” in bit positions of diversification data mask 261 and unmasked bits illustrated by arrows (↓) in bit positions of diversification data mask 261. The unmasked stable PUF output bits are then coalesced into ten example bits of a second PUF output value 286 (0000000101).

Since both the helper data 269 and the diversification data masks may perform a masking function, in an embodiment, the helper data information (i.e., which bits to mask, which to pass along) and the diversification data information (i.e., which bits to mask, which to pass along) may be combined into a single masking/passing information data mask. This is illustrated in FIG. 2D by diversified helper data 265. In FIG. 2D, the first PUF output value 285 is generated from raw PUF output value 281 using a single diversified helper data 265 which has the combined masking/passing information of helper data 269 and diversification data mask 261.

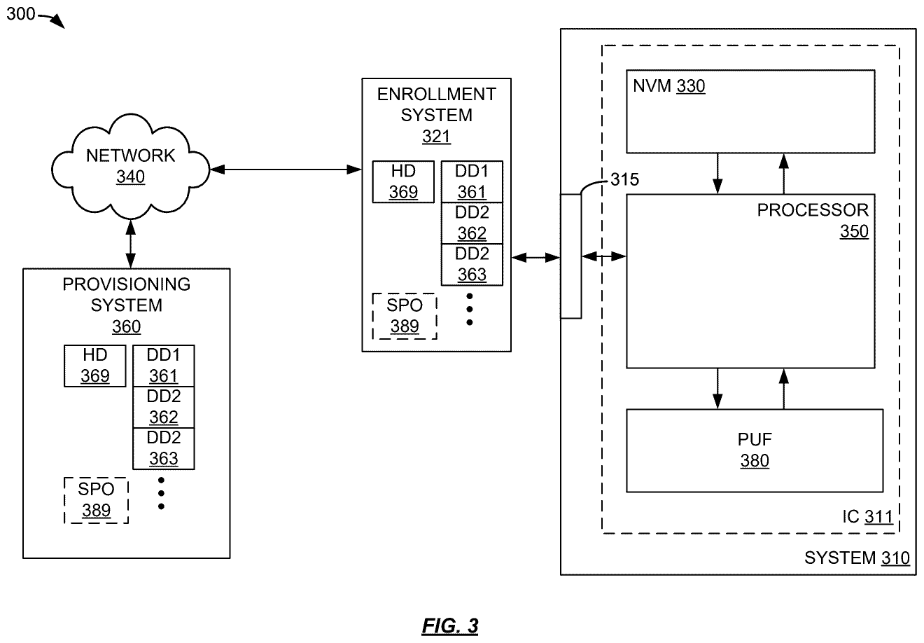

FIG. 3 illustrates a provisioning system. In FIG. 3, configuration system 300 comprises system 310, enrollment system 321, network 340, and provisioning system 360. System 310 includes nonvolatile memory (NVM) 330, processor 350, physically unclonable function (PUF) circuitry 380, and interface 315. In an embodiment, NVM 330, processor 350, and PUF circuitry 380 may be included on an implementation of integrated circuit 311 (e.g., microprocessor, security, authentication, and/or cryptographic function die) within system 310 (e.g., a printer cartridge). Enrollment system 321 is provided (or generates) a plurality of diversification data masks 361-363.

System 310 is operatively coupled to enrollment system 321 via interface 315. Enrollment system 320 is operatively coupled to system 310 to calculate or otherwise find multiple diversification data mask to be stored within provisioning system 360.

Enrollment system 321 (e.g., tester hardware used during device manufacture) is operatively coupled to provisioning system 360 via network 340.

Processor 350 of system 310 is operatively coupled to NVM 330 and PUF circuitry 380. Processor 350 is operatively coupled to interface 315. Processor 350 may communicate with enrollment system 321 via interface 315. In an embodiment, enrollment system 321 instructs processor 350 and PUF circuitry 380 to search for at least one helper data solutions that allows PUF circuitry 380 and processor 350 to generate at least one stable fingerprint value based on chip-unique variations of the physical characteristics (e.g., resistance, capacitance, threshold voltage, connectivity, etc.) of PUF circuitry 380. PUF circuitry 380 may include one or more tamper prevention (i.e., shielding) structures. The physical characteristics depend on random physical factors introduced during manufacturing. This causes the chip-to-chip variations in these physical characteristics to be unpredictable and uncontrollable which makes it virtually impossible to duplicate, clone, or modify PUF circuitry 380 and/or the tamper prevention structures without changing the fingerprint value.

In an embodiment, provisioning system 360 is provisioned by enrollment system 321 with helper data 369, diversification data masks 361-363, and optionally stable PUF output value 389 via network 340. Enrollment system 321 (e.g., a manufacturing tester) may generate diversification data masks 361-363 using a randomized stable bit selection process. In an embodiment, enrollment system 321 may also determine a stable PUF output value 389 associated with PUF circuitry 380 and helper data 369.

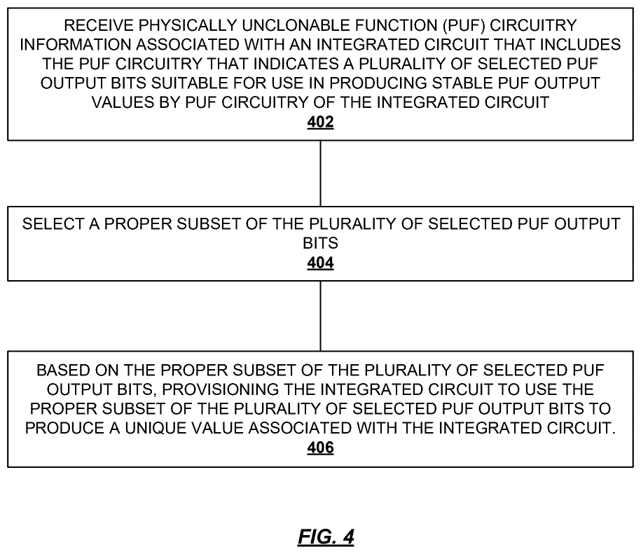

FIG. 4 is a flowchart illustrating a method of provisioning an integrated circuit. One or more steps illustrated in FIG. 4 may be performed by one or more of system 100, system 300, and/or their components. Physically unclonable function (PUF) circuitry information associated with an integrated circuit that includes the PUF circuitry that indicates a plurality of selected PUF output bits suitable for use in producing stable PUF output values by PUF circuitry of the integrated circuit is received (402). For example, at least one of system 110, integrated circuit 111, system 310, integrated circuit 311, or enrollment system 321 may control a PUF (e.g., PUF circuitry 180, PUF circuitry 280, PUF circuitry 380, etc.) to generate a multitude (e.g., 1,000, 10,000, etc.) of raw PUF output values that are analyzed to determine which PUF output bits meet a stability criteria and which PUF output bits do not.

A proper subset of the selected PUF output bits are selected (404). For example, enrollment system 321 may generate diversification data mask 262 by selecting a proper subset of the raw PUF output bits not masked by helper data 369. Enrollment system 321 may randomly (or using a randomized process) select the bits included in (or equivalently, not included in) proper subset of the raw PUF output bits not masked by helper data 369 to generate diversification data mask 262. Based on the proper subset of the plurality of selected PUF output bits, the integrated circuit is provisioned to use the proper subset of the plurality of selected PUF output bits to produce a unique value associated with the integrated circuit (406). For example, provisioning system 160 may store diversification data mask 262 in NVM 130 in association with helper data 369 so that integrated circuit 111 (and system 110) produces PUF output value 186.

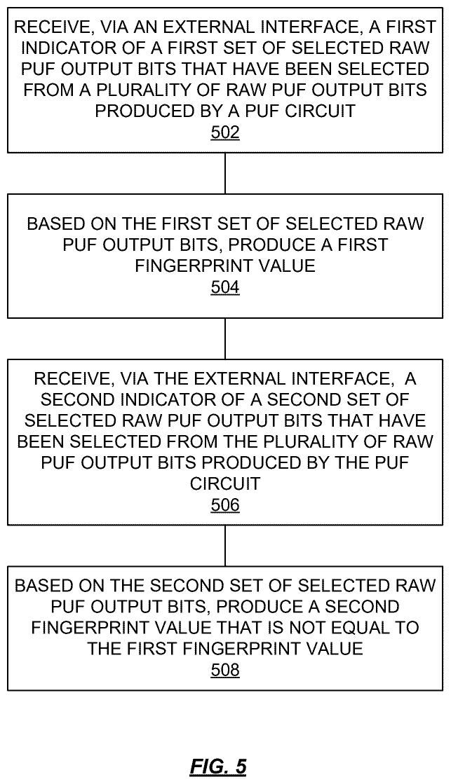

FIG. 5 is a flowchart illustrating a method of physically unclonable function diversification. One or more steps illustrated in FIG. 5 may be performed by one or more of system 100, system 300, and/or their components. Via an external interface, a first indicator of a first set of selected raw PUF output bits that have been selected from a plurality of raw PUF output bits produced by a PUF circuit is received (502). For example, NVM 130 may be initially provisioned with, and store, helper data 169 and diversification data mask 161. Helper data 169 and diversification data mask 161 may be stored in NVM 130 by an initial configuration/manufacturing system. In another example, helper data 169 and diversification data mask 161 (or equivalent combined diversified helper data) may be stored in NVM 130 by provisioning system 160.

Based on the first set of selected raw PUF output bits, a first fingerprint value is produced (504). For example, processor 150 may select stable bits from raw PUF output value 181 according to helper data 169 and diversification data mask 161 to produce first PUF output value 185. Via the external interface, a second indicator of a second set of selected raw PUF output bits that have been selected from the plurality of raw PUF output bits produced by the PUF circuit is received (506). For example, NVM 130 may, in response to provisioning system 160, be provisioned with, and/or configured to use, diversification data mask 162 (or equivalent combined diversified helper data). Based on the second set of selected raw PUF output bits, a second fingerprint value that is not equal to the first fingerprint value is produced (508). For example, processor 150 may select stable bits from raw PUF output value 182 according to helper data 169 and diversification data mask 162 to produce second PUF output value 186 which is not equal to first PUF output value 185.

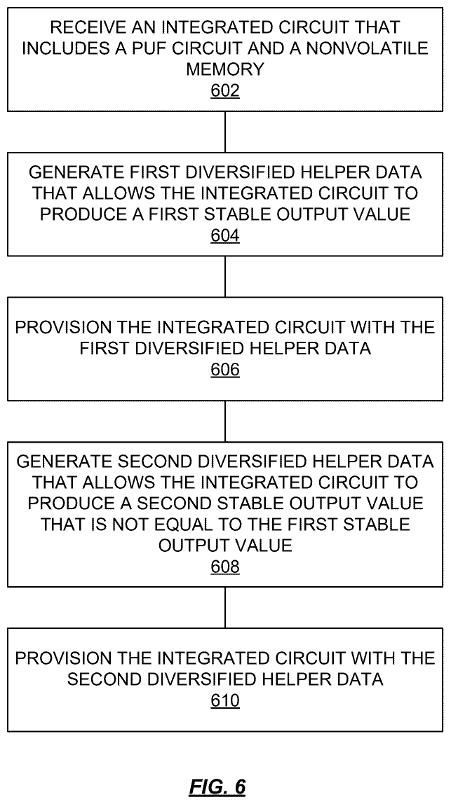

FIG. 6 is a flowchart illustrating a method of diversified helper data to produce a plurality of physically unclonable function output values. One or more steps illustrated in FIG. 6 may be performed by one or more of system 100, system 300, and/or their components. An integrated circuit that includes a PUF circuit and a nonvolatile memory is received (602). For example, host system 120 may be provided with system 110 which includes PUF circuitry 180 and NVM 130.

First diversified helper data that allows the integrated circuit to produce a first stable output value is generated (604). For example, enrollment system 321 may generate diversified helper data 265 which is combination of the masking functions of helper data 169 and diversification data mask 161. The integrated circuit is provisioned with the first diversified helper data (606). For example, diversified helper data 265 may be stored in NVM 130 by an initial configuration/manufacturing system. In another example, diversified helper data 265 may be stored in NVM 130 by provisioning system 160.

Second diversified helper data that allows the integrated circuit to produce a second stable output value that is not equal to the first stable output value is generated (608). For example, enrollment system 321 may generate diversified helper data which is combination of the masking functions of helper data 169 and diversification data mask 162 that will produce a second PUF output value that is not equal to the first PUF output value. The integrated circuit is provisioned with the second diversified helper data (610). For example, diversified helper data that is a combination of the masking functions of helper data 169 and diversification data mask 162 may be stored in NVM 130 by provisioning system 160.

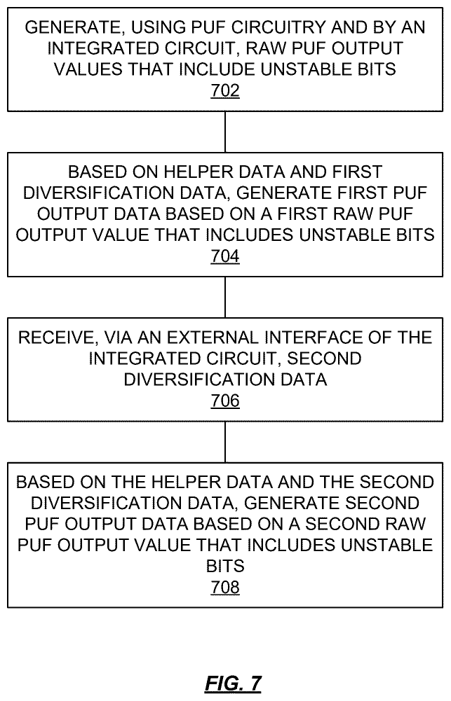

FIG. 7 is a flowchart illustrating a method of generating a plurality of physically unclonable function output values from raw physically unclonable function output bits. One or more steps illustrated in FIG. 7 may be performed by one or more of system 100, system 300, and/or their components. Using PUF circuitry and by an integrated circuit, raw PUF output values that include unstable bits are generated (702). For example, PUF circuitry 180 of integrated circuit 111 may generate raw PUF output values that include unstable bits.

Based on helper data and first diversification data, first PUF output data is generated based on a first raw PUF output value that includes unstable bits (704). For example, based on helper data 169 and diversification data mask 161, processor 150 may generate stable PUF output value 185 from raw PUF output value 181. Via an external interface of the integrated circuit, second diversification data is received (706). For example, integrated circuit 111 may receive for storage in NVM 130 and from system 110, via network 140, interface 125, and interface 115, diversification data mask 162. Based on helper data and the second diversification data, second PUF output data is generated based on a second raw PUF output value that includes unstable bits (708). For example, based on helper data 169 and diversification data mask 162, processor 150 may generate stable PUF output value 186 from raw PUF output value 182.

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of system 100, system 300, and their components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3-½ inch floppy media, CDs, DVDs, and so on.

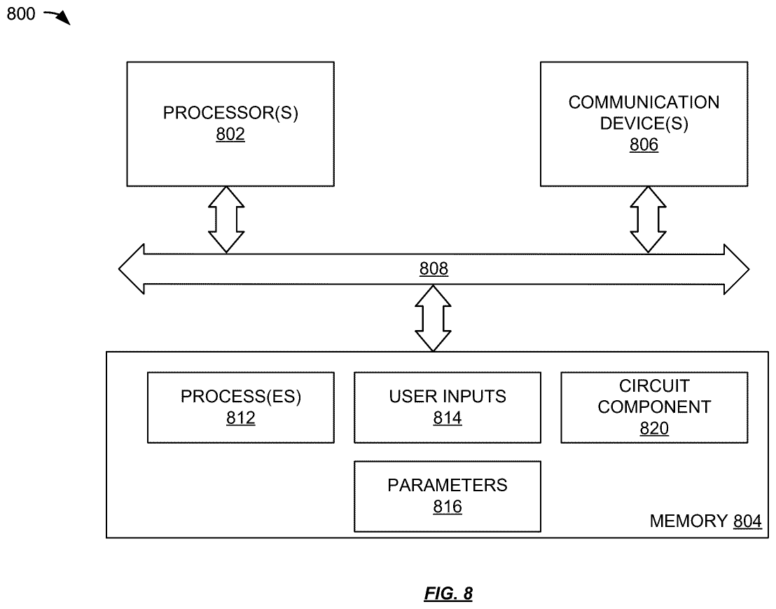

FIG. 8 is a block diagram illustrating one embodiment of a processing system 800 for including, processing, or generating, a representation of a circuit component 820. Processing system 800 includes one or more processors 802, a memory 804, and one or more communications devices 806. Processors 802, memory 804, and communications devices 806 communicate using any suitable type, number, and/or configuration of wired and/or wireless connections 808.

Processors 802 execute instructions of one or more processes 812 stored in a memory 804 to process and/or generate circuit component 820 responsive to user inputs 814 and parameters 816. Processes 812 may be any suitable electronic design automation (EDA) tool or portion thereof used to design, simulate, analyze, and/or verify electronic circuitry and/or generate photomasks for electronic circuitry. Representation 820 includes data that describes all or portions of system 100, and/or system 300, and their components, as shown in the Figures.

Representation 820 may include one or more of behavioral, register transfer, logic component, transistor, and layout geometry-level descriptions. Moreover, representation 820 may be stored on storage media or communicated by carrier waves.

Data formats in which representation 820 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email.

User inputs 814 may comprise input parameters from a keyboard, mouse, voice recognition interface, microphone and speakers, graphical display, touch screen, or other type of user interface device. This user interface may be distributed among multiple interface devices. Parameters 816 may include specifications and/or characteristics that are input to help define representation 820. For example, parameters 816 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 804 includes any suitable type, number, and/or configuration of non-transitory computer-readable storage media that stores processes 812, user inputs 814, parameters 816, and circuit component 820.

Communications devices 806 include any suitable type, number, and/or configuration of wired and/or wireless devices that transmit information from processing system 800 to another processing or storage system (not shown) and/or receive information from another processing or storage system (not shown). For example, communications devices 806 may transmit circuit component 820 to another system. Communications devices 806 may receive processes 812, user inputs 814, parameters 816, and/or circuit component 820 and cause processes 812, user inputs 814, parameters 816, and/or circuit component 820 to be stored in memory 804.

Implementations discussed herein include, but are not limited to, the following examples:

Example 1: A method of provisioning an integrated circuit: receiving physically unclonable function (PUF) circuitry information associated with the integrated circuit that includes the PUF circuitry that indicates a plurality of selected PUF output bits suitable for use in producing stable PUF output values by PUF circuitry of the integrated circuit; selecting a proper subset of the plurality of selected PUF output bits; and based on the proper subset of the plurality of selected PUF output bits, provisioning the integrated circuit to use the proper subset of the plurality of selected PUF output bits to produce a unique value associated with the integrated circuit.

Example 2: The method of example 1, further comprising: receiving PUF circuitry information that indicates a plurality of PUF output bit values associated with corresponding ones of the plurality of selected PUF output bits.

Example 3: The method of example 2, further comprising: based on the plurality of PUF output values, determining the unique value associated with the integrated circuit.

Example 4: The method of example 3, further comprising: generating a shared key value based on the unique value associated with the integrated circuit.

Example 5: The method of example 4, further comprising: securing data to be delivered to the integrated circuit using the shared key value.

Example 6: The method of example 1, further comprising: receiving, from the integrated circuit, an authentication value that is based on the unique value.

Example 7: The method of example 6, further comprising: based on the authentication value, determining whether the authentication value indicates that the integrated circuit is authentic.

Example 8: A system, comprising: a physically unclonable function (PUF) circuit to produce a plurality of raw PUF output bits; an interface to receive a first indicator of a first set of selected raw PUF output bits that have been selected from the plurality of raw PUF output bits; the system to produce a first fingerprint value based on the first set of selected raw PUF output bits; the interface to receive a second indicator of a second set of selected raw PUF output bits that have been selected from the plurality of raw PUF output bits; and the system to produce a second fingerprint value based on the second set of selected raw PUF output bits, the first fingerprint value and the second fingerprint value to be unequal.

Example 9: The system of example 8, further comprising: a provisioning system to receive information that indicates a plurality of selected raw PUF output bits that are suitable for use in producing stable PUF output values by the PUF circuit.

Example 10: The system of example 9, wherein the provisioning system is to select the first set of selected raw PUF output bits and is to select the second set of selected raw PUF output bits.

Example 11: The system of example 10, wherein the provision system is to transmit the first indicator and the second indicator via the interface.

Example 12: The system of example 11, wherein the provisioning system to also receive information that indicates values produced by the PUF circuit for each of the plurality of selected raw PUF output bits.

Example 13: The system of example 8, wherein a first cryptographic key value is based on the first fingerprint value and a second cryptographic key value is based on the second fingerprint value.

Example 14: The system of example 8, wherein the system is to transmit, to a verifier external to the system, first authentication information that is based on the first fingerprint value and second authentication information that is based on the second fingerprint value.

Example 15: A system, comprising: a first interface to a host system; an integrated circuit coupled to the first interface, the integrated circuit comprising: a physically unclonable function (PUF) circuit to produce a plurality of raw PUF output bits; the first interface to receive a first indicator of a first set of selected raw PUF output bits that have been selected from the plurality of raw PUF output bits; the physically unclonable function circuit to output a first fingerprint value based on the first set of selected raw PUF output bits; the first interface to receive a second indicator of a second set of selected raw PUF output bits that have been selected from the plurality of raw PUF output bits; and the physically unclonable function circuit to output a second fingerprint value based on the second set of selected raw PUF output bits, the first fingerprint value and the second fingerprint value to be unequal.

Example 16: The system of example 15, wherein the host system comprises: a second interface to a provisioning system.

Example 17: The system of example 16, wherein the provisioning system is to provide the first indicator to the host system via the second interface.

Example 18: The system of example 17, wherein the provisioning system is to receive information that indicates a plurality of selected raw PUF output bits that are suitable for use in producing stable PUF output values by the PUF circuit.

Example 19: The system of example 18, wherein the provisioning system to also receive information that indicates values produced by the PUF circuit for each of the plurality of selected raw PUF output bits.

Example 20: The system of example 16, wherein the provisioning system is to, based on the information that indicates values produced by the PUF circuit for each of the plurality of selected raw PUF output bits and the first set of selected raw PUF output bits, determine a shared key value that is known by the integrated circuit and is associated, by the integrated circuit, with the first fingerprint value.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of provisioning an integrated circuit:
receiving physically unclonable function (PUF) circuitry information associated with the integrated circuit that includes the PUF circuitry that indicates a plurality of selected PUF output bits suitable for use in producing stable PUF output values by PUF circuitry of the integrated circuit;
selecting a proper subset of the plurality of selected PUF output bits; and
based on the proper subset of the plurality of selected PUF output bits, provisioning the integrated circuit to use the proper subset of the plurality of selected PUF output bits to produce a unique value associated with the integrated circuit.

2. The method of claim 1, further comprising:
receiving PUF circuitry information that indicates a plurality of PUF output bit values associated with corresponding ones of the plurality of selected PUF output bits.

3. The method of claim 2, further comprising:
based on the plurality of PUF output values, determining the unique value associated with the integrated circuit.

4. The method of claim 3, further comprising:
generating a shared key value based on the unique value associated with the integrated circuit.

5. The method of claim 4, further comprising:
securing data to be delivered to the integrated circuit using the shared key value.

6. The method of claim 1, further comprising:
receiving, from the integrated circuit, an authentication value that is based on the unique value.

7. The method of claim 6, further comprising:
based on the authentication value, determining whether the authentication value indicates that the integrated circuit is authentic.

8. A system, comprising:
a physically unclonable function (PUF) circuit to produce a plurality of raw PUF output bits;
an interface to receive a first indicator of a first set of selected raw PUF output bits that have been selected from the plurality of raw PUF output bits;
the system to produce a first fingerprint value based on the first set of selected raw PUF output bits;
the interface to receive a second indicator of a second set of selected raw PUF output bits that have been selected from the plurality of raw PUF output bits; and
the system to produce a second fingerprint value based on the second set of selected raw PUF output bits, the first fingerprint value and the second fingerprint value to be unequal.

9. The system of claim 8, further comprising:
a provisioning system to receive information that indicates a plurality of selected raw PUF output bits that are suitable for use in producing stable PUF output values by the PUF circuit.

10. The system of claim 9, wherein the provisioning system is to select the first set of selected raw PUF output bits and is to select the second set of selected raw PUF output bits.

11. The system of claim 10, wherein the provision system is to transmit the first indicator and the second indicator via the interface.

12. The system of claim 11, wherein the provisioning system is to also receive information that indicates values produced by the PUF circuit for each of the plurality of selected raw PUF output bits.

13. The system of claim 8, wherein a first cryptographic key value is based on the first fingerprint value and a second cryptographic key value is based on the second fingerprint value.

14. The system of claim 8, wherein the system is to transmit, to a verifier external to the system, first authentication information that is based on the first fingerprint value and second authentication information that is based on the second fingerprint value.

15. A system, comprising:
a first interface to a host system;
an integrated circuit coupled to the first interface, the integrated circuit comprising:
a physically unclonable function (PUF) circuit to produce a plurality of raw PUF output bits;
the first interface to receive a first indicator of a first set of selected raw PUF output bits that have been selected from the plurality of raw PUF output bits;
the physically unclonable function circuit to output a first fingerprint value based on the first set of selected raw PUF output bits;
the first interface to receive a second indicator of a second set of selected raw PUF output bits that have been selected from the plurality of raw PUF output bits; and
the physically unclonable function circuit to output a second fingerprint value based on the second set of selected raw PUF output bits, the first fingerprint value and the second fingerprint value to be unequal.

16. The system of claim 15, wherein the host system comprises:
a second interface to a provisioning system.

17. The system of claim 16, wherein the provisioning system is to provide the first indicator to the host system via the second interface.

18. The system of claim 17, wherein the provisioning system is to receive information that indicates a plurality of selected raw PUF output bits that are suitable for use in producing stable PUF output values by the PUF circuit.

19. The system of claim 18, wherein the provisioning system to also receive information that indicates values produced by the PUF circuit for each of the plurality of selected raw PUF output bits.

20. The system of claim 16, wherein the provisioning system is to, based on the information that indicates values produced by the PUF circuit for each of the plurality of selected raw PUF output bits and the first set of selected raw PUF output bits, determine a shared key value that is known by the integrated circuit and is associated, by the integrated circuit, with the first fingerprint value.
